(19) United States
(12) Patent Application Publication
(10) Pub. No.: US 2022/0228858 A1
(43) Pub. Date: Jul. 21, 2022

(54) Laser assisted shifting and drive system alignment tool

(71) Applicants: Michael Scott Woelfel, Miamisburg, OH (US); Karl Ronald Heinze, West Chicago, IL (US); Brian Bates, Germantown, OH (US)

(72) Inventors: Michael Scott Woelfel, Miamisburg, OH (US); Karl Ronald Heinze, West Chicago, IL (US); Brian Bates, Germantown, OH (US)

(21) Appl. No.: 17/151,177

(22) Filed: Jan. 17, 2021

(51) Int. Cl. G01B 11/27; B62J 11/22

(52) U.S. Cl. CPC G01B 11/27; B62J 11/22

(57) ABSTRACT

A rear shifting and drive system, frame drop out, derailleur hanger and derailleur alignment tool provided with an axle attachment adapter/structure, a moveable collimated light source, and a collimated light source positioning linkage. The axle adapter/structure is attachable to a bicycle wheel axle and is rotationally moveable about the axis of the bicycle axle. The light source is moveably coupled to the axle adapter/structure by the light source positioning linkage, to move in a direction substantially parallel to the axis of the bicycle rear axle. The light source is positioned to shine the cross laser simultaneously on the axle or plane of the axle and the system components of the shifting and drive system. A visual vertical alignment of the cogs of the cassette, and derailleur jockey wheels, to each other in each shifting position, and relative perpendicular to the axle or plane of the axle provides an easy visual aid in assessing the relative positions and orientations of the components. As such, worn, damaged, bent, broken or maladjusted components of the shifting and drive system can be assessed and adjusted, repaired or replaced without disassembly of the shifting and drive system.

### CROSS REFERENCES TO RELATED APPLICATIONS

Provisional application 62/963,469

### FIELD OF INVENTION

The technology relates to the general field of gear, chain and sprocket alignment and has certain specific applications to bicycle, derailleur based, shifting and drive systems for the assessment and adjustment of the frame dropout, rear derailleur hanger, derailleur and other shifting and drive system components.

### BACKGROUND

Bicycling is becoming an increasingly more popular form of recreation, transportation, and competitive sport. Many bicycles use a rear derailleur to change gears (speeds). Typically, the rear derailleur is mounted to the bicycle frame dropout or to a rear derailleur hanger of the bicycle frame. Sometimes when the bicycle falls over, the rear derailleur hits the ground. This event can result in a bending of the frame dropout, derailleur hanger, or of the linkage components of the derailleur itself. When the frame dropout, derailleur hanger of the bicycle frame, or the derailleur linkage components of the derailleur are bent; this often results in poor shifting performance. Thus tools have been proposed for assessing and adjusting misalignment of the derailleur hanger. One example of such tool is a derailleur hanger alignment gauge model DAG-2.2 that is sold by Park Tool USA. While this tool generally works well, this tool requires the removal of the derailleur from the bicycle and measures the alignment of the derailleur hanger with respect to the bicycle wheel rim. The tool therefore requires effort for the removal of the derailleur and because the derailleur is detached, the tool cannot detect or correct any misalignment within the derailleur itself or components of the completely installed shifting and drive system. It can only measure the derailleur hanger as referenced to the bicycle wheel. As the hanger alignment gauge references the derailleur hanger to the wheel rim and not the axle, it makes isolating and identifying the root cause of shifting errors of each component in the shifting and drive system virtually ineffective. Measurement cannot be made of the complete system during operation and may be additionally affected by distortion or misalignment of the bicycle wheel/rim.

Messrs. Heer and Giesen, in patent DE10201711841483, disclose a device incorporating a LASER light for aiding in the adjustment of the derailleur travel limits. This device mounts by insertion into the derailleur mounting fastener/bolt and therefore cannot measure or adjust any misalignment caused by the bending of the derailleur hanger, the bicycle frame drop out and/or the derailleur linkage relative to the axle and is only useful for setting the limits of travel of the derailleur mechanism.

In view of the above, it will be apparent to those skilled in the art from this disclosure that there exists a need for an improved shifting and drive system alignment tool which allows for both assessment and adjustment of the frame dropout, rear derailleur hanger and derailleur. Furthermore this tool should provide means to assess and adjust components of the shifting and drive system both individually and as a system to insure perpendicularity to the axle providing a mechanical foundation from which the system can then be tuned for proper shifting using commonly known industry standard practices. The invention addresses the need in the art as well as other needs, which will become apparent to those skilled in the art from this disclosure.

### BRIEF SUMMARY OF THE INVENTION

The disclosed apparatus includes a cross beam collimated light source oriented to shed light on the rear shifting and drive components, both individually and as a system, while shining simultaneously on the plane of the axle of a bicycle. Components to be referenced to the axle may include: rear derailleur hanger, frame dropout, derailleur structure, jockey wheels, chain, cassette cogs, and wheel. The light source is moveably coupled to the bicycle's rear axle via an axle adapter and support motion system that allows the light source to shine a narrow cross beam on a plane coincident with the axis of the axle while simultaneously shining a line in a plane perpendicular to the axis. The motion system is so configured to allow the light source to move in a direction parallel to the axis defined by the axle while maintaining orientation perpendicular to the axis. This motion allows the user to visually inspect the positions and orientations of the rear shifting and drive components in each of the multiple positions set by the derailleur control. Inspection/assessment can be made with the entire system assembled while the rear wheels are static or in motion. By inspecting/assessing the pattern of the light beam on the shifting and drive components relative to each other and their respective perpendicularity to the axle, or plane of the axle, the user can identify misalignment caused by maladjustment and/or damage of the shifting, drive components, axle and more specifically the rear derailleur, frame dropout or derailleur hanger. Furthermore the apparatus provides means to rotate the light source about the center axis of the axle so that misalignment can be detected from different perspectives that would correspond to various misalignment geometries. These and other objects, features, aspects and advantages of the present invention will become apparent to those skilled in the art from the following detailed description, which, taken in conjunction with the annexed drawings, disclose a preferred embodiment of the present invention.

### BRIEF DESCRIPTION OF THE DRAWINGS

Various embodiments of the invention are disclosed in the following detailed description and accompanying drawings:

FIG. 1 illustrates a three-quarter view of the apparatus showing the first embodiment wherein the motion system is comprised of a parallel arm linkage.

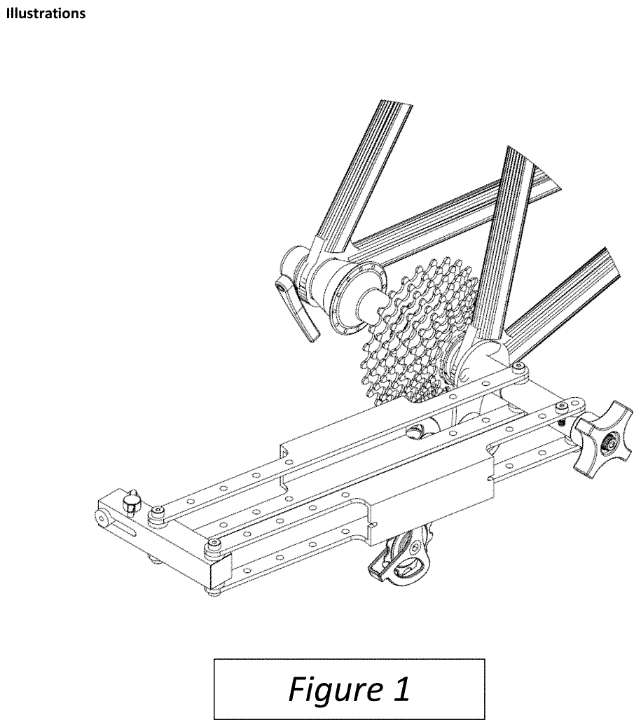

FIG. 2 illustrates a plan view of the apparatus with components identified.

FIG. 3 illustrates a bicycle rear axle hub, frame drop out, derailleur hanger and derailleur wherein the jockey wheels are in proper alignment with the first (largest) cog on the cassette.

FIG. 4 illustrates a bicycle rear axle hub, frame drop out, derailleur hanger and derailleur wherein the jockey wheels are NOT in proper alignment with the first (largest) cog on the cassette.

FIG. 5 is an isometric view from the left rear of the bicycle showing the general arrangement of the apparatus in relation to the derailleur and axle.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited by the claims.

Numerous specific details are set forth in the following description in order to provide a thorough understanding of the invention. However, the invention may be practiced according to the claims without some or all of these specific details. For purpose of clarity, technical material that is known in the technical fields related to the invention has not been described in detail so that the invention is not unnecessarily obscured.

### Definitions

Shifting system: A mechanical or electrical actuation system that enable the rider, via cockpit controls, to select a variety of speeds. It typically includes: rear derailleur hanger, derailleur, and jockey wheels.
Drive system: A set of mechanical components used to transmit the power exerted by the rider on the pedals via a crank, chain ring, bearings, chain and cogs of a multispeed rear cassette to rotational torque and speed to the rear wheel.
Cassette: An assembly of multiple cogs (sprockets) of varying diameters/number of teeth arranged coaxially on an axle and spaced to allow the drive chain to be deflected from engagement from any cog to any adjacent cog by means of deflection of the derailleur.
Cog: A sprocket included with additional sprockets of different diameters/number of teeth which when assembled together form a multi-speed rear cassette.
Derailleur: A mechanism or linkage attached to the bicycle frame with the purpose to deflect the chain from one cassette cog to an adjacent cog, under the control of the rider via mechanical cable or electrically operated shifting system.
Derailleur Hanger: A connecting link commonly provided to attach the derailleur to the bicycle frame dropouts. It is used as a sacrificial link to protect both the derailleur itself and the frame dropouts from damage.
Frame dropout: An attachment point for the derailleur hanger, derailleur and bicycle wheel.
Jockey Wheel: A pair of disc or sprocket shaped wheels inside the derailleur that directly deflect the chain from one cog to the adjacent cog in either direction.
Axle: The axle is a shaft, connected to each frame dropout, thru a wheel hub and bearing assemble, for the purpose of attaching the wheel to the bicycle. Axles come in a variety of sizes and attachment methods including quick release and thru hub.
Quick Release Axle: A commonly used axle consisting of a threaded shaft, commonly 5 mm in diameter, that mounts between the frame dropouts with a capped nut on one end and a levered quick release nut on the other end that releases or applies tension on the shaft by means of a lever actuated cam.
Thru Axle: Thru axles are large diameter (commonly 12 mm or larger), with a threaded end that screws directly into a threaded hole in the frame dropout. And is tightened by means of a wrench.
Hub: The hub is a tubular structure attached to the center of the wheel via spokes. It houses the bearings, system for mounting the cassette and machined mounting interface to accurately be located on the frame dropout and derailleur hanger. It is attached to the bicycle frame with the axle.

### DESCRIPTION

The invention relates to a shifting and drive system alignment tool for a bicycle and more specifically to an optical tool used for the assessment and adjustment of the frame dropouts, rear derailleur hanger and derailleur and other system components relative to the rear bicycle axle. This invention allows for the assessment and adjustment of shifting and drive components both individually and, as a system, in either a static or rotational moving condition.

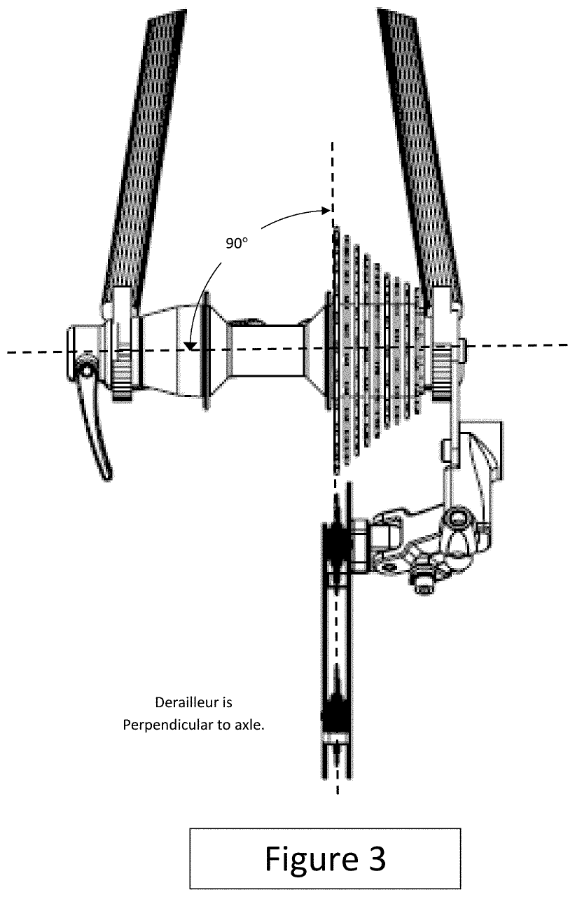

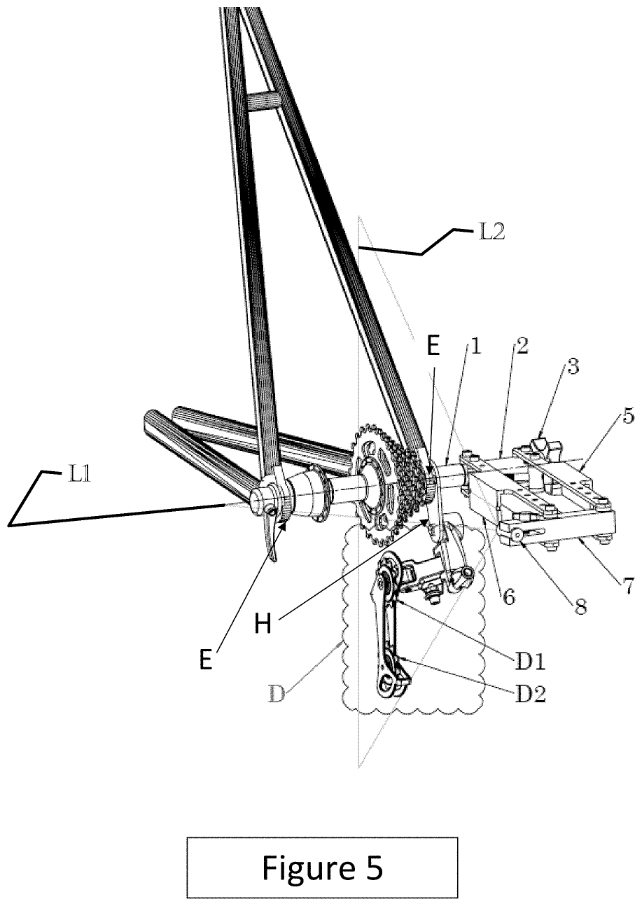

The use of a rear derailleur to shift bicycle speeds is well known. Typically, the rear derailleur is mounted to a derailleur hanger which is in turn attached to the bicycle frame dropouts, (FIG. 5). In some cases a derailleur hanger is not used and the derailleur is mounted directly to the bicycle frame. The frame dropouts, derailleur hanger and derailleur as a system are so constructed so that the small jockey wheels in the derailleur are at all times perpendicular to the axle in the bicycle wheel and indexed in line with each cog of the cassette, (FIG. 3). Accurate alignment of the frame dropouts, derailleur hanger and derailleur are therefore crucial to the proper functioning of bicycle gears.

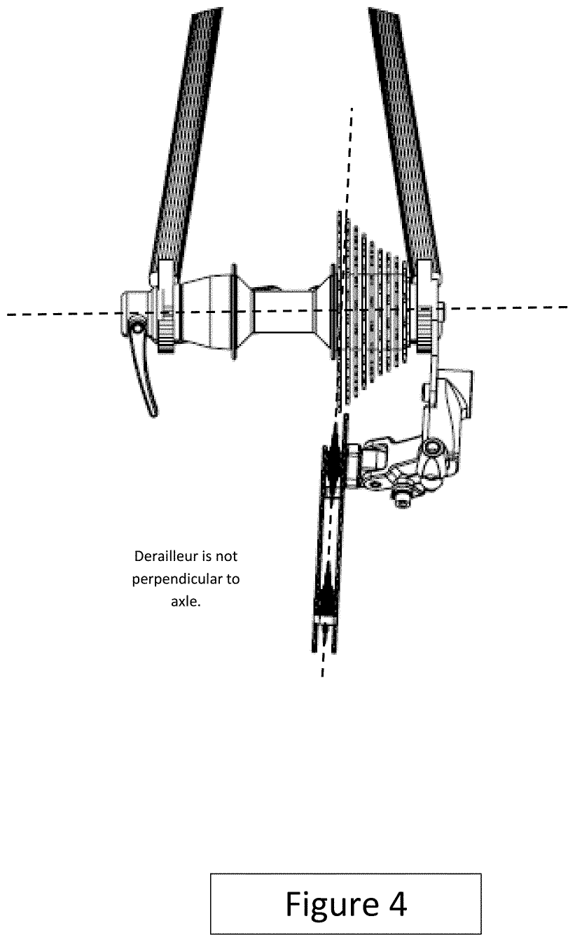

If a rear derailleur experiences an external force—for example when a bicycle falls over and the derailleur impacts the ground—the derailleur hanger is designed to absorb the force by bending inwardly towards the bicycle wheel, or possibly outwardly away from the frame, or twist (or in extreme cases, by shearing). In this condition, the derailleur jockey wheels will not be in alignment with the cog on the cassette, causing problems such as chain derailment or inadvertent gear changes, (FIG. 4). The derailleur hanger can therefore be viewed as a sacrificial component designed to minimize accidental damage to the more expensive components protecting the frame drop outs and derailleur itself. It is therefore sometimes necessary to replace and/or realign derailleur hangers to maintain optimum performance of shifting and drive systems. If the derailleur hanger is found to be within specification then assessment of the frame dropouts and derailleur itself should be performed. Alignment of frame drop outs, derailleur hangers and derailleur's is therefore a common and necessary part of bicycle maintenance.

The industry is known to provide tools for the purpose of assessing and adjusting misalignment of derailleur hangers of a bicycle. The basis of their operation is to accurately detect any deviations of a derailleur hanger's optimum position relative to the rim of a rear bicycle wheel. More specifically, the tools mount to a derailleur hanger in place of the derailleur and extend outwardly, either by a mechanism or by light source to interface with the rim of a bicycle wheel. For example, one such tool is offered by Shimano under its product number TL-RD11. Use of these tools necessitates a degree of skill for the removal of the derailleur from its mounting point and subsequent reinstallation and readjustment after the derailleur hanger is aligned. This disassembly is inconvenient and time consuming. Also, there can be damage, wear or other misalignment in the frame drop outs, derailleur itself, or other components of the shifting and drive system. These additional sources of error are not detected by the existing tools. Finally, by relying on the wheel rim as the frame of reference for alignment, the existing tools will be adversely affected by distortions in the wheel/rim.

In view of the above, the inventors of the herein disclosed apparatus have identified a need for an alternative frame drop out, derailleur hanger and derailleur alignment tool which simplifies the assessment and adjustment process of these and other components within the shifting and drive systems and, improves the accuracy and reliability of its measurements for the same as applied to a multispeed bicycle.

A frame drop out, derailleur hanger and derailleur assessment and adjustment tool is provided having a collimated light source which provides two perpendicular lines of light, an axle adapter and motion linkage for said light to provide positioning such that the crossed light beams may shine toward the bicycle axle and simultaneously on the components of the shifting and drive components to primarily include frame drop outs, derailleur hanger and derailleur. The perpendicular light beams may be rotated as a pair such that one line is visibly parallel to the bicycle axle. The linkage is rotatable mounted to the axle adapter so that the light source to be rotated about the axis of the axle to project toward the top, side or bottom of the axle and shifting and drive components (frame drop outs, derailleur hanger and derailleur) while maintaining alignment to the axis of the axle.

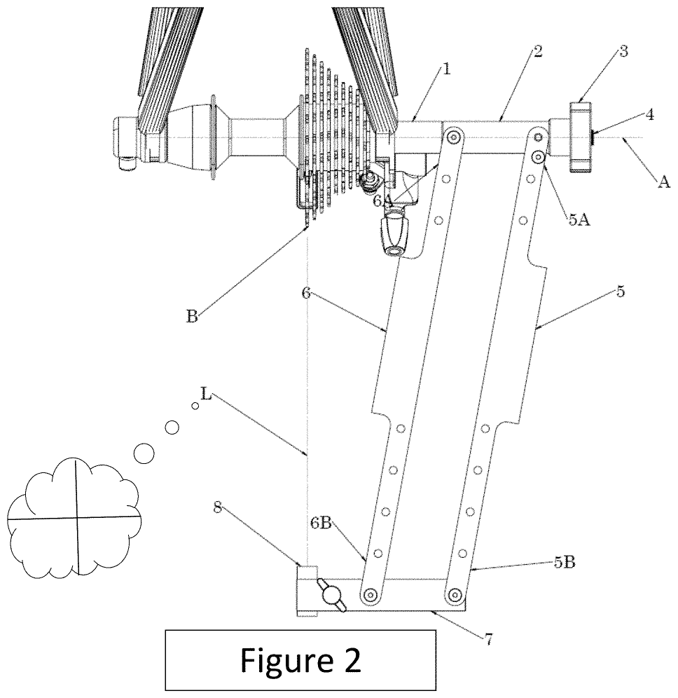

Referring to the figures and in particular FIG. 2, the apparatus includes an axle adapter (1) and a motion linkage having first and second ends. The first end comprised of a rotating link (2) mounted to the axle adapter by means of a threaded stud (4) and knob (3) such that the rotating link (2) is parallel to the axle axis (A) and rotates on an axis substantially congruent to axis (A). The first end of the linkage is comprised of a rotating link, (2), which is connected to the second end of the linkage, comprised of a light source holding link (7) by a plurality of parallel links, (5) and (6), each end of each link being connected by means of a pivoting joint, allowing the light source holding link (7) to move axially in a direction substantially parallel to the axis of the axle while the light source remains shining radially, directly toward the axle. The light source holding link at the second end of the motion linkage has two ends, the first end having geometry suitable for securely holding the light source oriented toward the axle and the second end connecting to the two parallel links. The light source (8) emitting two crossed lines of light Lis mounted to the light source holding link by means of a link or clamp. Preferably the light source (8) is a laser crossed line light source.

In use, referring to FIG. 5, the axle adapter (1) is fixedly attached, by means of helical screw threads, to the axle in place of the axle nut, which is an industry standard part with a quick-disconnect axle type bicycle. Or, in case of thru axle type bicycle, the original shaft is replaced with a modified shaft which mimics the connection properties of the quick-disconnect axle type bicycle. The remaining linkage and light source are attached to the axle adapter (1) by the stud (4) and knob (3) and oriented such that the light source (8) is shining toward the axle (B) and cogs of a cassette (B). The laser lines (L1) and (L2) are rotated, by rotation of the laser (8) itself, or by rotation of a lens

What is claimed is:

1. A shifting and drive system inspection tool comprising:
An attachment structure attaching the apparatus directly to a bicycle axle.
A light source collimated or otherwise restricted to cast light along a pair of perpendicular narrow lines and adjustably coupled to the attachment structure by means of a light source mounting structure and a motion linkage.
A mounting linkage for the light source moveably coupled to the light source and attachment structure, providing means for the light to be positioned such that the narrow light is shining radially toward the axle and on a cog in the cassette and providing rotational positioning of one line to be parallel with the bicycle axle.
The motion linkage having a first end and a second end with the first end moveably coupled to the attachment structure such that the motion linkage may be rotated about the axis of the bicycle axle and the second end moveably coupled to the light source such that the light source may move in a direction parallel to the axle while maintaining the orientation of the light source such that the plane defined by one narrow line of light remains perpendicular to the axle during the circumferential and axial movement.

2. The tool in claim 1 wherein the light source is a LASER light source with a crossed line output consisting of two perpendicular projected lines

3. The tool in claim 1 wherein motion linkage is a parallel 4 bar type linkage with the four links forming a parallelogram with pivoting connections.
